(19) United States
(12) Patent Application Publication
(10) Pub. No.: US 2016/0111027 A1
(43) Pub. Date: Apr. 21, 2016

(54) EMBOSSED MAGNETIC RECEPTIVE SHEET

(71) Applicant: XCEL PRODUCTS, INC., Champlin, MN (US)

(72) Inventors: STEPHEN LAWSON PETERSON, WAYZATA, MN (US); CLAY MATTHEW REIERSON, COON RAPIDS, MN (US)

(73) Assignee: XCEL PRODUCTS, INC., Champlin, MN (US)

(21) Appl. No.: 14/919,176

(22) Filed: Oct. 21, 2015

Related U.S. Application Data
(60) Provisional application No. 62/066,464, filed on Oct. 21, 2014.

(51) Int. Cl. G09F 7/04; B44F 9/10; B44F 9/02; B44C 1/24; B32B 27/18; B32B 3/30; B32B 27/30; B32B 27/28; B44F 9/04; B32B 27/08

(52) U.S. Cl. CPC G09F 7/04; B44F 9/04; B44F 9/10; B44F 9/02; B32B 27/08; B32B 27/18; B32B 3/30; B32B 27/304; B32B 27/283; B44C 1/24; B32B 2255/10; B32B 2307/208; B32B 2264/102; B32B 2451/00; B32B 2255/28

(57) ABSTRACT

A magnetic receptive media comprising at least one first polymer layer and a magnetic receptive layer comprising a polymer and a magnetic receptive material or a magnetized material, wherein the at least one first polymer layer is embossed with a three-dimensional pattern.

### CROSS-REFERENCE TO RELATED APPLICATIONS

This application claims priority under 35 U.S.C. §119 to U.S. Provisional Application Ser. No. 62/066,464, filed Oct. 21, 2014, the entirety of which is incorporated herein by reference.

### BACKGROUND OF THE INVENTION

The present invention relates generally to an embossed magnetic receptive or magnetized sheet.

Embossing to create an impression or design into a surface such as paper, cloth metal, leather and polymer materials is well known. In this process, plates or rollers are pressed against the surface to leave the desired impression therein.

It is also known in the art to manufacture magnetic receptive media having an extruded, cast or calendered polymer layer that includes both a polymer material and a magnetic receptive material, and a printable display layer, such as a white polyvinyl chloride layer or other polymer material layer wherein patterns can be printed thereon.

Magnetic receptive media of this type are typically coupled to a magnetic base component that is permanently magnetized and installed such as on a wall, floor or any other structure through the use of an adhesive or mechanical fixture. Magnetic receptive media can be customized for any purpose such as for wall and floor decorations, displays and other advertising media and are readily changed when desired. See, for example, U.S. Pat. No. 7,225,568.

There remains a need in the art for improved, interchangeable graphic displays that can be used for decorations, displays and other advertising media.

Without limiting the scope of the invention a brief summary of some of the claimed embodiments of the invention is set forth below.

### SUMMARY OF THE INVENTION

In one aspect, the present invention relates to a magnetic receptive media comprising at least one first polymer layer and a magnetic receptive layer comprising a polymer and a magnetic receptive material or a magnetized material, wherein the at least one first polymer layer is embossed with a three-dimensional pattern.

In another aspect, the present invention relates to a method of providing a magnetic receptive media with a three dimensional pattern including providing the magnetic receptive media, the media comprising at least one polymer layer and at least one magnetic receptive layer or at least one magnetized layer and embossing a three dimensional pattern in the polymer layer.

These and other aspects, embodiments and advantages of the present disclosure will become immediately apparent to those of ordinary skill in the art upon review of the Detailed Description and Claims to follow.

### DETAILED DESCRIPTION OF THE INVENTION

While embodiments of the present disclosure may take many forms, there are described in detail herein specific embodiments of the present disclosure. This description is an exemplification of the principles of the present disclosure and is not intended to limit the disclosure to the particular embodiments illustrated.

The present invention relates to a magnetic receptive media, the media including at least one first polymer layer and at least one magnetic receptive layer comprising a polymer and a magnetic receptive material, wherein the at least one first polymer layer is embossed with a three-dimensional pattern.

While polymer layers for embossing are preferred herein, other layers such as paper or paper products can be embossed as well.

In some embodiments, the magnetic receptive media may be a multilayered polymer substrate including a magnetic receptive core layer for adhering the substrate to a permanently magnetized surface, and one or more layers attached to either one or both sides of the core layer, wherein at least one outermost surface of the layers is absent or substantially absent of magnetic receptive particle material, comprises a three-dimensional pattern embossed therein and is suitable for producing printed graphic images thereon.

Any desired pattern, design, emblem, etc. can be embossed in the polymer layer.

Examples include, but are not limited to mosaics, wood grain patterns, canvas textures, geometric shapes, curved or straight lines, brushed metal patterns, etc.

The scope of the present invention is not limited by the pattern that may be embossed into the polymer layer.

In some embodiments, it may be desirable to emboss a trademark beneath a printed graphic image.

Suitably, the magnetic receptive layer may be extruded, coated, cast or calendered out of a solvent paste wherein a polymer material includes magnetic receptive particles incorporated therein. The polymer material may be present in the magnetic receptive layer from about 30 wt-% to about 95 wt%, suitably about 50 wt-% to about 95 wt-%, more suitably about 60 wt-% to about 90 wt-% and most suitably about 70 wt-% to about 85 wt-% of the polymer material, and from about 5 wt-% to about 70 wt-% of the magnetic receptive particles, suitably about 5 wt-% to about 50 wt-%, more suitably about 10 wt-% to about 40 wt-% and most suitably about 15 wt-% to about 30 wt-%.

The polymer material employed in the magnetic receptive layer is not limited to any particular thermoplastic resin, and, while preferably thermoplastic in nature, it can also be thermosetting as well. Suitably, the polymer material comprises a polymer or combination of polymers that have little tack, unless the magnetic receptive layer is disposed between the at least one polymer layer and another polymer layer that is the same or different than the at least one polymer layer.

Examples of suitable polymer materials include, but are not limited to, polymers formed from monomers of olefins, esters, ethers, styrene, vinyl, amide, acrylate, urethane, imide, etc., copolymers and terpolymers thereof, and mixtures thereof. Particular examples include polyethylene and copolymers of ethylene such as ethylene vinyl acetate copolymers.

The polymer layer may be formed from any suitable polymer material known in the art, but not limited to, those polymers formed from monomers of olefins, esters, ethers, styrene, vinyl, amides, acrylates, urethanes, siloxanes, etc., copolymers and terpolymers thereof, and mixtures thereof.

Specific examples include, but are not limited to, polyesters, polyethylenes, polyolefins, polyvinyl choride and silicone.

These lists are intended for illustrative purposes only, and not as a limitation on the scope of the present invention. One of ordinary skill in the art can readily substitute other suitable polymer materials without departing from the scope of the present invention.

The magnetic receptive particle material is typically an oxide mineral that is ferrimagnetic and includes different materials or ions in different oxidation states.

Typically, the magnetic receptive material is an iron oxide of the formula A(B)₂O₄ wherein A and B are metals of Fe⁺² and Fe⁺³ or Fe₃O₄.

In some embodiments, the magnetic receptive material is magnetite. In some embodiments, a magnetized material is employed herein. Magnetized materials are typically ferromagnetic, for example, ferrite, which is a ceramic composed of iron oxide of the formula Fe₂O₃ combined with one or more additional metallic elements.

One example of a material that can be magnetized has the general formula M²⁺O6Fe₂O₃ (MFe₁₂O₁₉) where M is a divalent metal. Suitably, M is barium, strontium or lead.

These materials are intended for illustrative purposes only, and not as a limitation on the scope of the invention. One of ordinary skill in the art can readily substitute one magnetic receptive material or one magnetizable material for another without departing from the scope of the invention.

Suitably, the particles having a mean particle size of about 40 microns or less, and suitably about 4 to about 28 microns, although this range can vary.

The polymer layer can be embossed with any three-dimensional pattern desired using any suitable embossing equipment and method wherein the pattern is etched into the polymer layer under heat and pressure with a predetermined pattern or pattern. Typically, this is accomplished through the use of rollers or plates that are heated and pressure is applied to the substrate, typically between two rollers. Suitably, one roller, referred to as an emboss patterning roller comprises the embossing pattern, design or pattern, and the other roller comprises a smooth flat surface to which the magnetic receptive layer comes into contact.

The magnetic receptive media may be fed through the embossing equipment either in web form or in sheet form.

Any suitable printing method can be employed including, but not limited to, digital, gravure, offset, flexo and screen printing.

Suitably, the pattern is disposed over the embossing pattern, or design.

In some embodiments, a symbol, emblem or trademark design may be embossed beneath a graphic image in the form of a digital photo or embossed watermarks, for example.

All published documents, including all US patent documents and US patent publications, mentioned anywhere in this application are hereby expressly incorporated herein by reference in their entirety. Any copending patent applications, mentioned anywhere in this application are also hereby expressly incorporated herein by reference in their entirety. Citation or discussion of a reference herein shall not be construed as an admission that such is prior art.

The description provided herein is not to be limited in scope by the specific embodiments described which are intended as single illustrations of individual aspects of certain embodiments. The methods, compositions and devices described herein can comprise any feature described herein either alone or in combination with any other feature(s) described herein. Indeed, various modifications, in addition to those shown and described herein, will become apparent to those skilled in the art from the foregoing description and accompanying drawings using no more than routine experimentation. Such modifications and equivalents are intended to fall within the scope of the appended claims.

What is claimed is:

1. A magnetic receptive media comprising:
at least one first polymer layer; and
a magnetic receptive layer comprising a polymer and a magnetic receptive material or a magnetized material;
wherein the at least one first polymer layer is embossed with a three-dimensional pattern.

2. The magnetic receptive media of claim 1 wherein the at least one first polymer layer comprises a member selected from the group consisting of polymers comprising monomers of vinyl, ethylene, propylene, ester, siloxanes, and copolymers and terpolymers thereof.

3. The magnetic receptive media of claim 1 wherein the at least one first polymer layer comprises a polymer comprising vinyl monomers or siloxane monomers.

4. The magnetic receptive media of claim 1 wherein the at least one first polymer layer comprises polyvinyl chloride.

5. The magnetic receptive media of claim 1 wherein the magnetic receptive layer comprises iron oxide.

6. The magnetic receptive media of claim 1 wherein the magnetic receptive layer comprises a polymer comprising vinyl monomers.

7. The magnetic receptive media of claim 1 having a thickness of about 10 to about 20 mils.

8. The magnetic receptive media of claim 1 having a thickness of about 10 to about 15 mils.

9. The magnetic receptive media of claim 1 having a thickness of about 11 to about 13 mils.

10. The magnetic receptive media of claim 1 having a width of up to about 74 inches.

11. The magnetic receptive media of claim 1 having a width of up to about 126 inches.

12. The magnetic receptive media of claim 1 wherein the three-dimensional pattern comprises a mosaic, a wood grain pattern, canvas texture, geometric patterns, curved or straight lines or brushed metal patterns.

13. The magnetic receptive media of claim 12 comprises a graphic image disposed thereon.

14. The magnetic receptive media of claim 10 comprising a digitally printed pattern disposed thereon.

15. The magnetic receptive media of claim 1 wherein a pattern or design is embossed below a printed pattern.

16. A method of providing a magnetic receptive media with a three dimensional pattern, the method comprising:
providing the magnetic receptive media, the media comprising at least one polymer layer and at least one magnetic receptive or magnetized layer; and
embossing a three-dimensional pattern in the polymer layer.

17. The method of claim 16 wherein the three-dimensional pattern comprises a pattern or a design.

18. The method of claim 16 wherein the three-dimensional pattern comprises a mosaic, a wood grain pattern, canvas texture, geometric patterns, curved or straight lines or brushed metal patterns.

19. The method of claim 16 comprising printing a graphic image over the three-dimensional pattern.

20. The method of claim 17 wherein printing comprises gravure, digital, offset, flexo, and screen printing.
